(19) United States
(12) Patent Application Publication
(10) Pub. No.: US 2024/0053454 A1
(43) Pub. Date: Feb. 15, 2024

(54) JOINT CALIBRATION METHOD AND SYSTEM FOR EXTERNAL PARAMETERS OF VEHICLE-MOUNTED LASER RADARS

(71) Applicant: CHANGSHA XINGSHEN INTELLIGENT TECHNOLOGY CO., LTD, Hunan (CN)

(72) Inventors: Deyuan MENG, Hunan (CN); Tingbo HU, Hunan (CN); Xiangjing AN, Hunan (CN)

(73) Assignee: CHANGSHA XINGSHEN INTELLIGENT TECHNOLOGY CO., LTD, Hunan (CN)

(21) Appl. No.: 18/278,007

(22) PCT Filed: Sep. 22, 2021
(86) PCT No.: PCT/CN2021/119580

§ 371 Date: Aug. 21, 2023

(30) Foreign Application Priority Data
Feb. 24, 2021 (CN) 202110206177.7

(51) Int. Cl. G01S 7/497; G01S 17/931

(52) U.S. Cl. CPC G01S 7/497; G01S 17/931

(57) ABSTRACT

A vehicle-mounted lidar external parameter joint calibration method and system, a medium and a device. Said calibration method comprises: respectively acquiring point cloud data of the reference radar and point cloud data of a radar to be calibrated, obtain a corresponding plane A point cloud and a corresponding plane B point cloud, and calibrating a rotation matrix; rotating the plane A point cloud corresponding to said radar by means of the rotation matrix, and obtaining a z component of a translation matrix on the basis of the rotated plane A point cloud and the plane A point cloud corresponding to the reference radar; and obtaining a calibration column point cloud from the point cloud data of the reference radar, and obtaining x and y components of the translation matrix on the basis of the calibration column point cloud and the rotated plane A point cloud corresponding to said radar.

### CROSS-REFERENCE TO RELATED APPLICATIONS

This application is based on and claims priority to Chinese Patent Application No. 202110206177.7, entitled “Joint Calibration Method and System for External Parameters of Vehicle-mounted Laser Radars”, filed on Feb. 24, 2021, which is incorporated herein by reference in its entirety, as one part of this application.

### TECHNICAL FIELD

The invention mainly relates to the technical field of radar calibration, in particular to a joint calibration method and system for external parameters of vehicle-mounted laser radars.

### BACKGROUND

To improve the scene sensing ability of autonomous vehicles and make up for scanning blind zones of a single radar, it has become a common configuration at present to deploy multiple 3D laser radars on the autonomous vehicles. The calibration accuracy of multi-radar systems has a crucial impact on the use of the multi-radar systems. Two common calibration methods for multi-radar systems are as follows:

1. Appearance-Based Method

The appearance-based method is a registration problem, which resolves spatial deviations between multiple radars by means of corresponding appearance clues in the environment. The key to this method is to search for data existing in all radars, wherein the data may be points, lines, surfaces, or the like. When this method is used, an overdetermined equation for different expressions of the same data in different radar coordinate systems needs to be constructed, and then a transformation matrix between the two coordinate systems is resolved.

By adopting the appearance-based method, physical quantities have to be repeatedly measured manually, and the calibration process is complex; and because the beams of 3D laser radars are sparse, it is difficult to obtain the same data in different radar coordinate systems, and measurement errors are large.

2. Motion-Based Method

The motion-based method takes calibration as an adequately studied eye-hand calibration problem, which calculates external parameters by combining motions of all available sensors. The eye-hand calibration problem is to resolve X in AX=XB, where A and B are motions of two sensors, and X is the transformation between A and B. The motion-based method can be expanded to multi-sensor calibration in the outdoor environment.

Although the motion-based calibration method has been extensively developed, and the accuracy of calibration results are quietly likely be affected by cumulative drifts of estimated motions.

### SUMMARY

The technical issue to be settled by the invention is to solve the technical problems in the prior art by providing a simple and quick joint calibration method and system for external parameters of vehicle-mounted laser radars, a medium and a device.

In order to solve the above technical problems, technical solution proposed by the present invention is:

A joint calibration method for external parameters of vehicle-mounted laser radars, a preset calibration scene comprises a plane A perpendicular to a Z-axis of a reference radar S, a plane B not perpendicular to the Z-axis of the reference radar S, and a calibration pillar E parallel to the Z-axis of the reference radar S, wherein the reference radar S and a to-be-calibrated radar C are located on a same vehicle, and the plane A, the plane B and the calibration pillar E are all located within a scanning range of the reference radar S and the to-be-calibrated radar C; the joint calibration method comprises:
(1) separately acquiring point cloud data of the reference radar S and point cloud data of the to-be-calibrated radar C to obtain corresponding plane A point clouds and corresponding plane B point clouds, and calibrating a rotation matrix by means of the plane A point clouds and the plane B point clouds;
(2) rotating the plane A point cloud corresponding to the to-be-calibrated radar C through the rotation matrix, and obtaining a z component of a point cloud calibration translation matrix by means of the rotated plane A point cloud corresponding to the to-be-calibrated radar C and the plane A point cloud corresponding to the reference radar S; and
(3) obtaining a calibration pillar E point cloud from point cloud data of the reference radar S, and obtaining an x component and a y component of the point cloud calibration translation matrix by means of the calibration pillar E point cloud and the rotated plane A point cloud corresponding to the to-be-calibrated radar C.

As a further improvement of the above technical solution, the Step (1) specifically comprises:
(1.1) obtaining a frame of point cloud data P_{S} of the reference radar S, defining, by window selection, a plane A point could P_{S}^{A} from the point cloud data P_{S}, and extracting a centripetal plane normal vector V_{S}^{A}; defining, by window selection, a plane B point cloud P_{S}^{B} from the point cloud data P_{S}, and extracting a centripetal plane normal vector V_{S}^{B};
obtaining a frame of point cloud data P_{C} of the to-be-calibrated radar C, defining, by window selection, a plane A point cloud P_{C}^{A} from the point cloud data P_{C}, and extracting a centripetal plane normal vector V_{C}^{A}; defining, by window selection, a plane B point cloud P_{C}^{B} from the point cloud data P_{C}, and extracting a centripetal plane normal vector V_{C}^{B};
(1.2) forming a matrix M_{S}=[V_{S}^{A}, V_{S}^{B}] by the centripetal plane normal vector V_{S}^{A} of the plane A measured by the reference radar S and the centripetal plane normal vector V_{S}^{B} of the plane B measured by the reference radar S;
forming a matrix M_{C}=[V_{C}^{A}, V_{C}^{B}] by the centripetal plane normal vector V_{C}^{A} of the plane A measured by the reference radar C and the centripetal plane normal vector V_{C}^{B} of the plane B measured by the reference radar C;
defining an overdetermination matrix H=M_{S}*M_{C}^{T}; and
(1.3) Obtaining an optimal estimated rotation matrix \hat{R} according to the overdetermination matrix H;

As a further improvement of the above technical solution, the Step (1.3) comprises the following specific steps:
(1.3.1) performing SVD on the overdetermination matrix H to obtain [U, Λ, V]=svd(H);
(1.3.2) calculating a rotation matrix R=VU^{T}; and
(1.3.3) calculating the optimal estimated rotation matrix \hat{R}: calculating a determinant det(R) of R; if det(R)=1, determining that R is forward mapping of \hat{R}, that is, \hat{R}=R; or, if et(R)=−1, determining that R is reverse mapping of \hat{R}, multiplying a third column of the matrix V by −1, that is, V′=[v1, v2, −v3], and \hat{R}=X′=V′U^{T}.

As a further improvement of the above technical solution, the Step (2) specifically comprises:
(2.1) rotating the point cloud P_{C}^{A} by means of the optimal estimated rotation matrix \hat{R}, and marking the rotated point cloud as P_{C}^{A}′; extracting plane point clouds, calculating a mean value of z components of the plane point clouds, and marking the mean value as z_{C}^{A}′;
(2.2) performing plane segmentation on the point cloud P_{S}^{A} to extract plane point clouds, calculating a mean value of z components of the plane point clouds, and marking the mean value as z_{S}^{A}; and
(2.3) calculating a translation quantity T_{Z}=z_{S}^{A}−z_{C}^{A}′.

As a further improvement of the above technical solution, the Step (3) specifically comprises:
(3.1) defining, by window selection, a calibration pillar E point cloud Y_{S}^{E} in the point cloud P_{S}, and performing Hough circle transform by means of x and y components of the point cloud Y_{S}^{E} to obtain a circle center, which is marked as (x_{S}^{E}, y_{S}^{E});
defining, by window selection, a calibration pillar E point cloud Y_{C}^{E} in the point cloud P_{C}^{A}′, and performing Hough circle transform by means of x and y components of the point cloud Y_{C}^{E} to obtain a circle center, which is marked as (x_{C}^{E}, y_{C}^{E}); and
(3.2) Calculating a translation quantity Tₓ=x_{S}^{E}−x_{C}^{E}, and a translation quantity T_{y}=y_{S}^{E}−y_{C}^{E}.

As a further improvement of the above technical solution, in the Step (1.1) and Step (1.2), an RANSAC algorithm is used for performing plane segmentation to extract the centripetal plane normal vectors.

As a further improvement of the above technical solution, the plane A is the ground, the plane B is a wall, and the calibration pillar E is a tube.

The present invention further discloses a joint calibration method for external parameters of vehicle-mounted laser radars, a preset calibration scene comprises a plane A perpendicular to a Z-axis of a reference radar S, a plane B not perpendicular to the Z-axis of the reference radar S, and a calibration pillar E parallel to the Z-axis of the reference radar S, wherein the reference radar S and a to-be-calibrated radar C are located on a same vehicle, and the plane A, the plane B and the calibration pillar E are all located within a scanning range of the reference radar S and the to-be-calibrated radar C; the joint calibration system comprises:
a first module configured to acquire point cloud data of the reference radar S and point cloud data of the to-be-calibrated radar C separately to obtain corresponding plane A point clouds and corresponding plane B point clouds, and calibrate a rotation matrix by means of the plane A point clouds and the plane B point clouds;
a second module configured to rotate the plane A point cloud corresponding to the to-be-calibrated radar C through the rotation matrix, and obtain a z component of a point cloud calibration translation matrix by means of the rotated plane A point cloud corresponding to the to-be-calibrated radar C and the plane A point cloud corresponding to the reference radar S; and
a third module configured to obtain a calibration pillar E point cloud from point cloud data of the reference radar S, and obtain an x component and a y component of the point cloud calibration translation matrix by means of the calibration pillar E point cloud and the rotated plane A point cloud corresponding to the to-be-calibrated radar C. The present invention further discloses a computer-readable storage medium,
having a computer program stored thereon, wherein the when the computer program is executed by a processor, the steps of the joint calibration method for external parameters of vehicle-mounted laser radars mentioned-above are performed.

The present invention further discloses a computer device, comprising a memory having a computer program stored thereon, and a processor, wherein when the computer program is executed by the processor, the steps of the joint calibration method for external parameters of vehicle-mounted laser radars mentioned-above are performed.

Compared with the prior art, the invention has the following advantages:

The joint calibration method for external parameters of vehicle-mounted laser radars provided by the invention is implemented in a preset calibration scene, and the preset calibration scene comprises a plane A, a plane B and a calibration pillar E, thus being simple in overall structure and easy to construct; according to the calibration method, rotational calibration and translational calibration of external parameters are separated, and a rotation matrix is calibrated by means of plane A point clouds and plane B point clouds; a z component of a translation matrix is obtained by means of a rotated plane A point cloud corresponding to a to-be-calibrated radar C and a plane A point cloud corresponding to a reference radar S; and an x component and a y component of the point cloud calibration translation matrix are obtained by means of a calibration pillar E point cloud and the rotated plane A point cloud corresponding to the to-be-calibrated radar C, so the calibration process is simple and quick, and calibration is accurate and reliable.

### BRIEF DESCRIPTION OF THE DRAWINGS

FIG. 1 is a flow diagram of a method according to one embodiment of the invention.

FIG. 2 is an arrangement diagram of a calibration scene according to one embodiment of the invention.

### DESCRIPTION OF THE EMBODIMENTS

The invention will be further described below in conjunction with the accompanying drawings and specific embodiments.

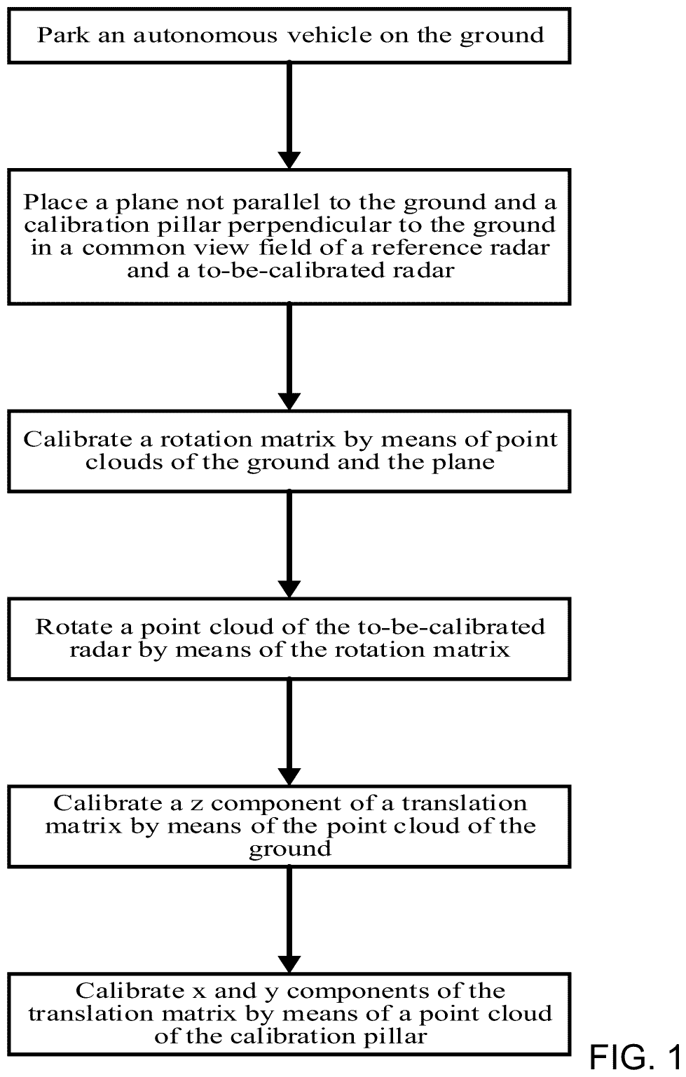

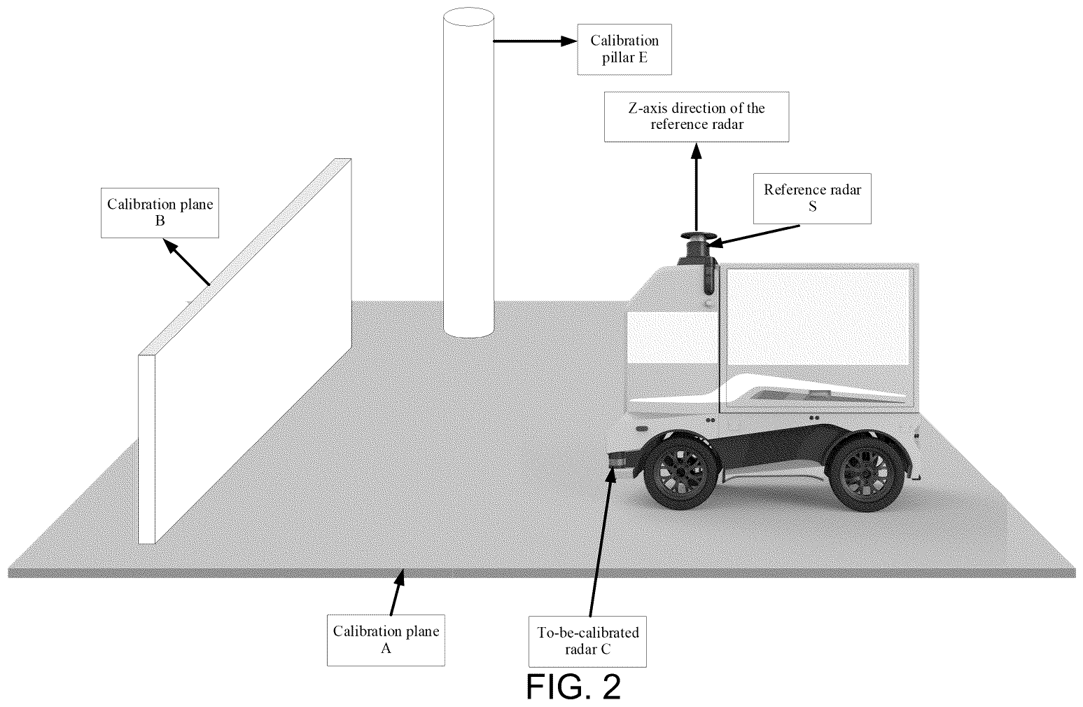

As shown in FIG. 1, this embodiment provides a joint calibration method for external parameters of vehicle-mounted laser radars, which is implemented in a preset calibration scene. The preset calibration scene comprises a plane A perpendicular to a Z-axis of a reference radar S, a plane B not perpendicular to the Z-axis of the reference radar S, and a calibration pillar E parallel to the Z-axis of the reference radar S, wherein the reference radar S and a to-be-calibrated radar C are located on a same vehicle, the plane A, the plane B and the calibration pillar E are all located within the scanning range of the reference radar S and the to-be-calibrated radar C. Specifically, as shown in FIG. 2, the joint calibration method comprises the following steps:
(1) Separately acquiring point cloud data of the reference radar S and point cloud data of the to-be-calibrated radar C to obtain corresponding plane A point clouds and corresponding plane B point clouds, and calibrating a rotation matrix by means of the plane A point clouds and the plane B point clouds;
(2) Rotating the plane A point cloud corresponding to the to-be-calibrated radar C through the rotation matrix, and obtaining a z component of a point cloud calibration translation matrix by means of the rotated plane A point cloud corresponding to the to-be-calibrated radar C and the plane A point cloud corresponding to the reference radar S; and
(3) Obtaining a calibration pillar E point cloud from point cloud data of the reference radar S, and obtaining an x component and a y component of the point cloud calibration translation matrix by means of the calibration pillar E point cloud and the rotated plane A point cloud corresponding to the to-be-calibrated radar C.

The joint calibration method for external parameters of vehicle-mounted laser radars provided by the invention is implemented in a preset calibration scene, and the preset calibration scene comprises a plane A, a plane B and a calibration pillar E, thus being simple in overall structure and easy to construct; according to the calibration method, rotational calibration and translational calibration of external parameters are separated, and a rotation matrix is calibrated by means of plane A point clouds and plane B point clouds; a z component of a translation matrix is obtained by means of a rotated plane A point cloud corresponding to a to-be-calibrated radar C and a plane A point cloud corresponding to a reference radar S; and an x component and a y component of the point cloud calibration translation matrix are obtained by means of a calibration pillar E point cloud and the rotated plane A point cloud corresponding to the to-be-calibrated radar C, so the calibration process is simple and quick, and calibration is accurate and reliable.

In one specific embodiment, Step (1) specifically comprises:
(1.1) Obtaining a frame of point cloud data P_{S} of the reference radar S, defining, by window selection, a plane A point could P_{S}^{A} from the point cloud data P_{S}, and extracting a centripetal plane normal vector V_{S}^{A}; defining, by window selection, a plane B point cloud P_{S}^{B} from the point cloud data P_{S}, and extracting a centripetal plane normal vector V_{S}^{B};
Obtaining a frame of point cloud data P_{C} of the to-be-calibrated radar C, defining, by window selection, a plane A point cloud P_{C}^{A} from the point cloud data P_{C}, and extracting a centripetal plane normal vector V_{C}^{A}; defining, by window selection, a plane B point cloud P_{C}^{B} from the point cloud data P_{C}, and extracting a centripetal plane normal vector V_{C}^{B};
(1.2) Forming a matrix M_{S}=[V_{S}^{A},V_{S}^{B}] by the centripetal plane normal vector V_{S}^{A} of the plane A measured by the reference radar S and the centripetal plane normal vector V_{S}^{B} of the plane B measured by the reference radar S;
Forming a matrix M_{C}=[V_{S}^{A}, V_{S}^{B}] by the centripetal plane normal vector V_{C}^{A} of the plane A measured by the reference radar C and the centripetal plane normal vector V_{C}^{B} of the plane B measured by the reference radar C;
Defining an overdetermination matrix H=M_{S}*M_{C}^{T}; and
(1.3) Obtaining an optimal estimated rotation matrix \hat{R} according to the overdetermination matrix H.

In one specific embodiment, Step (1.3) comprises the following specific steps:
(1.3.1) Performing SVD on the overdetermination matrix \hat{R} to obtain [U, Λ, V]=svd(H);
(1.3.2) Calculating a rotation matrix R=VU^{T}; and
(1.3.3) Calculating the optimal estimated rotation matrix \hat{R}: calculating a determinant det(R) of R; if det(R)=1, determining that R is forward mapping of \hat{R}, that is, \hat{R}=R; or, if et(R)=−1, determining that R is reverse mapping of \hat{R}, multiplying a third column of the matrix V by −1, that is, V′=[v1, v2, −v3], and \hat{R}=X′=V′U^{T}.

In one specific embodiment, Step (2) specifically comprises:
(2.1) Rotating the point cloud P_{C}^{A} by means of the optimal estimated rotation matrix \hat{R}, and marking the rotated point cloud as P_{C}^{A}′; extracting plane point clouds, calculating a mean value of z components of the plane point clouds, and marking the mean value as z_{C}^{A}′;
(2.2) Performing plane segmentation on the point cloud P_{S}^{A} to extract plane point clouds, calculating a mean value of z components of the plane point clouds, and marking the mean value as z_{S}^{A}; and
(2.3) Calculating a translation quantity T_{Z}=z_{S}^{A}−z_{C}^{A}′.

In one specific embodiment, Step (3) specifically comprises:
(3.1) Defining, by window selection, a calibration pillar E point cloud Y_{S}^{E} in the point cloud P_{S}, and performing Hough circle transform by means of x and y components of the point cloud Y_{S}^{E} to obtain a circle center, which is marked as (x_{S}^{E}, y_{S}^{E});
Defining, by window selection, a calibration pillar E point cloud Y_{C}^{E} in the point cloud P_{C}^{A}′, and performing Hough circle transform by means of x and y components of the point cloud Y_{C}^{E} to obtain a circle center, which is marked as (x_{C}^{E}, y_{C}^{E}); and
(3.2) Calculating a translation quantity Tₓ=x_{S}^{E}−x_{C}^{E}, and a translation quantity T_{y}=y_{S}^{E}−y_{C}^{E}.

In one specific embodiment, in Step (1.1) and Step (1.2), an RANSAC algorithm is used for performing plane segmentation to extract the centripetal plane normal vectors.

In one specific embodiment, the plane A is the ground, the plane B is a wall, the calibration pillar E is a tube (such as a PVC water tube), and the whole calibration scene is simple and easy to construct.

The invention further discloses a joint calibration system for external parameters of vehicle-mounted laser radars. A calibration method corresponding to the calibration system is implemented in a preset calibration scene. The preset calibration scene comprises a plane A perpendicular to a Z-axis of a reference radar S, a plane B not perpendicular to the Z-axis of the reference radar S, and a calibration pillar E parallel to the Z-axis of the reference radar S, wherein the reference radar S and a to-be-calibrated radar C are located on a same vehicle, the plane A, the plane B and the calibration pillar E are all located within the scanning range of the reference radar S and the to-be-calibrated radar C. The calibration system comprises:

A first module configured to acquire point cloud data of the reference radar S and point cloud data of the to-be-calibrated radar C separately to obtain corresponding plane A point clouds and corresponding plane B point clouds, and calibrate a rotation matrix by means of the plane A point clouds and the plane B point clouds; A second module configured to rotate the plane A point cloud corresponding to the to-be-calibrated radar C through the rotation matrix, and obtain a z component of a point cloud calibration translation matrix by means of the rotated plane A point cloud corresponding to the to-be-calibrated radar C and the plane A point cloud corresponding to the reference radar S; and

A third module configured to obtain a calibration pillar E point cloud from point cloud data of the reference radar S, and obtain an x component and a y component of the point cloud calibration translation matrix by means of the calibration pillar E point cloud and the rotated plane A point cloud corresponding to the to-be-calibrated radar C.

The calibration system is used for implementing the calibration method mentioned above, and has the advantages of the calibration method.

The invention further discloses a computer-readable storage medium, having a computer program stored therein, and when the computer program is executed by a processor, the steps of the joint calibration method for external parameters of vehicle-mounted laser radars are performed. The invention further discloses a computer device, comprising a memory and a processor, wherein a computer program is stored on the memory, and when the computer program is executed by a processor, the steps of the joint calibration method for external parameters of vehicle-mounted laser radars are performed. All or part of the process of the method in the above embodiment may be implemented by corresponding hardware instructed by a computer program, the computer program may be stored in the computer-readable stored medium, and when the computer program is executed by a processor, the steps of the method in the above embodiment can be performed. Wherein, the computer program comprises a computer program code, the computer program code may be in the form of a source code, an object code or an executable file, or be in some intermediate forms. The computer-readable medium may comprise: any entity or device capable of carrying the computer program, a recoding medium, a USB flash disk, a mobile hard disk drive, a diskette, a CD, a computer memory, a read-only memory (ROM), a random access memory (RAM), an electrical carrier signal, a telecommunication signal, a software distribution medium, or the like. The memory may be used for storing the computer program and/or modules, and the processor realizes various functions by running or executing the computer program and/or modules stored in the memory and calling data stored in the memory. The memory may comprise a high-speed random access memory, a non-volatile memory, such as a hard disk, an internal memory and a plug-in type hard disk, a smart media card (SMC), a secure digital (SD) card, a flush card, at least one disk memory device, a flash memory, or other volatile solid-state memories.

The above embodiments are merely the preferred ones of the invention, and the protection scope of the invention is not limited to these embodiments. All technical solutions obtained based on the concept of the invention should fall within the protection scope of the invention. It should be pointed out that any improvements and embellishments made by those ordinarily skilled in the art without departing from the principle of the invention should fall within the protection scope of the invention.

To the claims:

1. A joint calibration method for external parameters of vehicle-mounted laser radars, wherein a preset calibration scene comprises a plane A perpendicular to a Z-axis of a reference radar S, a plane B not perpendicular to the Z-axis of the reference radar S, and a calibration pillar E parallel to the Z-axis of the reference radar S, wherein the reference radar S and a to-be-calibrated radar C are located on a same vehicle, and the plane A, the plane B and the calibration pillar E are all located within a scanning range of the reference radar S and the to-be-calibrated radar C; the joint calibration method comprises:
(1) separately acquiring point cloud data of the reference radar S and point cloud data of the to-be-calibrated radar C to obtain corresponding plane A point clouds and corresponding plane B point clouds, and calibrating a rotation matrix by means of the plane A point clouds and the plane B point clouds;
(2) rotating the plane A point cloud corresponding to the to-be-calibrated radar C through the rotation matrix, and obtaining a z component of a point cloud calibration translation matrix by means of the rotated plane A point cloud corresponding to the to-be-calibrated radar C and the plane A point cloud corresponding to the reference radar S; and
(3) obtaining a calibration pillar E point cloud from point cloud data of the reference radar S, and obtaining an x component and a y component of the point cloud calibration translation matrix by means of the calibration pillar E point cloud and the rotated plane A point cloud corresponding to the to-be-calibrated radar C.

2. The joint calibration method for external parameters of vehicle-mounted laser radars according to claim 1, wherein Step (1) specifically comprises:
(1.1) obtaining a frame of point cloud data P_{S} of the reference radar S, defining, by window selection, a plane A point could P_{S}^{A} from the point cloud data P_{S}, and extracting a centripetal plane normal vector V_{S}^{A}; defining, by window selection, a plane B point cloud P_{S}^{B} from the point cloud data P_{S}, and extracting a centripetal plane normal vector V_{S}^{B};
obtaining a frame of point cloud data P_{C} of the to-be-calibrated radar C, defining, by window selection, a plane A point cloud P_{S}^{A} from the point cloud data P_{C}, and extracting a centripetal plane normal vector V_{C}^{A}; defining, by window selection, a plane B point cloud P_{C}^{B} from the point cloud data P_{C}, and extracting a centripetal plane normal vector V_{C}^{B};
(1.2) forming a matrix M_{S}=[V_{S}^{A},V_{S}^{B}] by the centripetal plane normal vector V_{S}^{A} of the plane A measured by the reference radar S and the centripetal plane normal vector V_{S}^{B} of the plane B measured by the reference radar S;
forming a matrix M_{C}=[V_{C}^{A}, V_{C}^{B}] by the centripetal plane normal vector V_{C}^{A} of the plane A measured by the reference radar C and the centripetal plane normal vector V_{C}^{B} of the plane B measured by the reference radar C;
defining an overdetermination matrix H=M_{S}*M_{C}^{T}; and
(1.3) Obtaining an optimal estimated rotation matrix \hat{R} according to the overdetermination matrix H.

3. The joint calibration method for external parameters of vehicle-mounted laser radars according to claim 2, wherein Step (1.3) comprises the following specific steps:
(1.3.1) performing SVD on the overdetermination matrix H to obtain [U, Λ, V]=svd(H);
(1.3.2) calculating a rotation matrix R=VU^{T}; and
(1.3.3) calculating the optimal estimated rotation matrix \hat{R}: calculating a determinant det(R) of R; if det(R)=1, determining that R is forward mapping of \hat{R}, that is, \hat{R}=R; or, if et(R)=−1, determining that R is reverse mapping of \hat{R}, multiplying a third column of the matrix V by −1, that is, V′=[v1, v2, −v3], and \hat{R}=X′=V′U^{T}.

4. The joint calibration method for external parameters of vehicle-mounted laser radars according to claim 3, wherein Step (2) specifically comprises:
(2.1) rotating the point cloud P_{C}^{A} by means of the optimal estimated rotation matrix \hat{R}, and marking the rotated point cloud as P_{C}^{A}′; extracting plane point clouds, calculating a mean value of z components of the plane point clouds, and marking the mean value as z_{C}^{A}′;
(2.2) performing plane segmentation on the point cloud P_{S}^{A} to extract plane point clouds, calculating a mean value of z components of the plane point clouds, and marking the mean value as z_{S}^{A}; and
(2.3) calculating a translation quantity T_{Z}=z_{S}^{A}−z_{C}^{A}′.

5. The joint calibration method for external parameters of vehicle-mounted laser radars according to claim 4, wherein Step (3) specifically comprises:
(3.1) defining, by window selection, a calibration pillar E point cloud Y_{S}^{E} in the point cloud P_{S}, and performing Hough circle transform by means of x and y components of the point cloud Y_{S}^{E} to obtain a circle center, which is marked as (x_{S}^{E}, y_{S}^{E});
defining, by window selection, a calibration pillar E point cloud Y_{C}^{E} in the point cloud P_{C}^{A}′, and performing Hough circle transform by means of x and y components of the point cloud Y_{C}^{E} to obtain a circle center, which is marked as (x_{C}^{E}, y_{C}^{E}); and
(3.2) Calculating a translation quantity T₌x_{S}^{E}−x_{C}^{E}, and a translation quantity T_{y}=y_{S}^{E}−y_{C}^{E}.

6. The joint calibration method for external parameters of vehicle-mounted laser radars according to claim 2, wherein in Step (1.1) and Step (1.2), an RANSAC algorithm is used for performing plane segmentation to extract the centripetal plane normal vectors.

7. The joint calibration method for external parameters of vehicle-mounted laser radars according to claim 2, wherein the plane A is the ground, the plane B is a wall, and the calibration pillar E is a tube.

8. A joint calibration method for external parameters of vehicle-mounted laser radars, wherein a preset calibration scene comprises a plane A perpendicular to a Z-axis of a reference radar S, a plane B not perpendicular to the Z-axis of the reference radar S, and a calibration pillar E parallel to the Z-axis of the reference radar S, wherein the reference radar S and a to-be-calibrated radar C are located on a same vehicle, and the plane A, the plane B and the calibration pillar E are all located within a scanning range of the reference radar S and the to-be-calibrated radar C; the joint calibration system comprises:
a first module configured to acquire point cloud data of the reference radar S and point cloud data of the to-be-calibrated radar C separately to obtain corresponding plane A point clouds and corresponding plane B point clouds, and calibrate a rotation matrix by means of the plane A point clouds and the plane B point clouds;
a second module configured to rotate the plane A point cloud corresponding to the to-be-calibrated radar C through the rotation matrix, and obtain a z component of a point cloud calibration translation matrix by means of the rotated plane A point cloud corresponding to the to-be-calibrated radar C and the plane A point cloud corresponding to the reference radar S; and
a third module configured to obtain a calibration pillar E point cloud from point cloud data of the reference radar S, and obtain an x component and a y component of the point cloud calibration translation matrix by means of the calibration pillar E point cloud and the rotated plane A point cloud corresponding to the to-be-calibrated radar C.

9. A computer-readable storage medium, having a computer program stored thereon, wherein the when the computer program is executed by a processor, the steps of the joint calibration method for external parameters of vehicle-mounted laser radars according to claim 1 are performed.

10. A computer device, comprising a memory having a computer program stored thereon, and a processor, wherein when the computer program is executed by the processor, the steps of the joint calibration method for external parameters of vehicle-mounted laser radars according to claim 1 are performed.
